(19) United States
(12) Patent Application Publication
(10) Pub. No.: US 2006/0204624 A1
(43) Pub. Date: Sep. 14, 2006

(54) Process and apparatus for enhancing peel oil extraction

(75) Inventors: Alexander Patist, Maple Grove, MN (US); Tamirat Tadesse Mindaye, Lakeland, FL (US); Todd Matthiesen, Winter Haven, FL (US)

Correspondence Address: CARGILL, INC., 15407 MCGINTY ROAD WEST, WAYZATA, MN, 55391-2399, US

(73) Assignee: Cargill, Inc., Wayzata, MN (US)

(21) Appl. No.: 11/078,702

(22) Filed: Mar. 14, 2005

(51) Int. Cl. A21D 13/00

(52) U.S. Cl. 426/283

(57) ABSTRACT

A process of enhancing peel oil extraction from citrus fruit comprises providing a mixture containing citrus solids and water, subjecting the citrus solids and water mixture to high power ultrasonic energy under conditions sufficient to separate peel oil from the citrus solids, and recovering the peel oil. An apparatus for extracting peel oil from citrus fruit comprises an extractor, a conduit for flowing a citrus mixture containing citrus solids and water, and an ultrasonic generator for subjecting the citrus mixture to high power ultrasonic energy to separate peel oil from the citrus solids. In another embodiment, sonic energy is used to de-emulsify peel oil in a citrus mixture.

### FIELD OF THE INVENTION

The present invention is directed to extracting peel oil from citrus materials and, more particularly, to the use of ultrasonic energy for enhancing peel oil extraction from citrus materials.

### BACKGROUND OF THE INVENTION

Citrus peels contain oils which commonly are used as flavoring additives in bakery goods, soft drinks, citrus juices, and the like. For example, orange peel oil often is used as an additive for orange juice concentrate and orange juice to enhance aroma and flavor. Citrus peel oils also are used as additives in non-food products such as perfumes, soaps, cosmetics, lotions, and the like. Citrus peel oils generally are high in aroma and flavor components derived from and associated with a particular fruit, and typically contain up to about 90 wt % d-limonene.

Peel oils are contained in numerous oval sacs which are irregularly distributed in the outer, colored (or “flavedo”) portion of the peel of citrus fruits, such as grapefruit, oranges, and the like. One technique used for obtaining peel oils is expression. During expression, the sacs are mechanically ruptured (e.g., by crushing the peel) and the oils contained in the sacs are liberated. Water is sprayed onto the citrus material to help prevent the peel oils from volatilizing. The oils are then collected in a slurry containing the sprayed water along with cell water and cell debris. The citrus peel oil is separated and clarified by decantation, centrifugation, filtration, or similar process.

Another technique for recovering citrus peel oils, especially orange peel oil, is a de-oiling process. In the de-oiling process, the entire outer peel portion of the whole fruit is lightly cut or pricked by a scarifier device. The cuts or pricks allow the peel oil to exude from the sacs and out of the peel. Water is used to wash the exuded peel oil from the fruit. The peel oil is then collected, separated and clarified in the same or similar manner as described above for expressed peel oil. The de-oiling process is often used to limit the amount of peel oil in the extracted juice.

Peel oils often are recovered during the course of juice making. Screw finishers are extensively used in the citrus fruit processing industry to separate fruit juice from the mixture of the juice, pulp and seeds produced by extraction apparatus; to separate frit (fine peel particles) from a mixture of water, oil and frit; and to separate particulate pulp matter from citrus pulp wash mixtures. In one type of screw finisher, the discharge opening for the solid (or deliquified) phase of the mixture is formed between the relatively large end of the screw of the finisher and a stripper ring which is biased toward the end of the screw by a pneumatic diaphragm valve that is set to maintain a selected pressure, thereby maintaining a relatively constant pressure within the finisher under varying flow rates through the finisher. U.S. Pat. No. 4,287,058 to Larsen discloses a screw finisher which has paddles for propelling the deliquified solid phase of the mixture about the end of the screw tube, and stripper members for urging the solid material into the discharge opening.

The extractors, e.g., screw finishers, typically recover less than all of the peel oil present in the citrus fruit. That is, a portion of the peel oil remains entrapped in the frit or other citrus solids or emulsified in water. The efficiency of peel oil recovery varies depending on the type of fruit and the particular extractor used. In many cases, only about 75% of the available peel oil is recovered. In general, using more water in the process improves the efficiency of separating peel oil from frit or other citrus solids. However, higher amounts of water dilute the peel oil, which makes it more difficult to separate from the mixture.

It would be desirable to develop a process and apparatus for enhancing the recovery of peel oil from frit or other citrus solids. It also would be desirable to improve peel oil recovery by de-emulsifying peel oil that is contained in citrus extract mixtures.

### SUMMARY OF THE INVENTION

According to one embodiment of the present invention, a process of enhancing peel oil extraction from citrus fruit is provided. The process comprises providing a mixture containing citrus solids and water, subjecting the citrus solids and water mixture to high power ultrasonic energy under conditions sufficient to separate peel oil from the citrus solids, and recovering the peel oil.

An apparatus for enhancing peel oil extraction from citrus fruit comprises an extractor for extracting water, oil, and citrus solids from citrus fruit. The apparatus has a conduit for flowing from the extractor a citrus mixture containing water and citrus solids. An ultrasonic generator is operatively connected to a probe for subjecting the citrus mixture to high power ultrasonic energy to separate peel oil from the citrus solids.

In another embodiment of the invention, a process of enhancing peel oil extraction from citrus fruit is provided. The process comprises providing a citrus mixture comprising an extract of citrus fruit selected from the group consisting of orange, grapefruit, lemon, lime, tangerine, and mixtures thereof, wherein the citrus mixture contains emulsified peel oil. The citrus mixture is subjected to sonic energy under conditions sufficient to de-emulsify the peel oil, and the peel oil is recovered.

An apparatus for extracting peel oil from citrus fruit in accordance with an alternative embodiment comprises an extractor for extracting water, oil, and citrus solids from citrus fruit. The apparatus has a conduit for flowing from the extractor a citrus mixture containing emulsified peel oil. A sonic generator is operatively connected to a probe for subjecting the citrus mixture to sonic energy to de-emulsify the peel oil.

The present invention provides an efficient and cost-effective way to increase recovery of valuable peel oil from citrus materials. In the preferred practice of the invention, the efficiency of peel oil recovery can be significantly increased as compared to presently used citrus extraction techniques.

### BRIEF DESCRIPTION OF THE DRAWINGS

The objects, features, and advantages of the invention will be apparent from the following more detailed description of certain embodiments of the invention and as illustrated in the accompanying drawings in which:

FIG. 1 is a schematic illustration of an apparatus having an ultrasonic flow cell to enhance peel oil recovery in accordance with one embodiment of the present invention;

FIG. 2 is a graphical illustration of orange peel oil recovery as function of power and flow rate where a low amplitude radial probe was used;

FIG. 3 graphically illustrates orange peel oil recovery as function of power and flow rate where a low amplitude cascade probe was used;

FIG. 4 graphically illustrates orange peel oil recovery as function of power and flow rate where a high amplitude cascade probe was used;

FIG. 5 illustrates a three hour performance test for orange peel oil recovery in accordance with one embodiment of the invention;

FIG. 6 illustrates a three hour performance test for grapefruit peel oil recovery in accordance with one embodiment of the invention;

FIG. 7 is an illustration of a device that can be used for applying sonic energy to a citrus mixture to de-emulsify peel oil in accordance with an alternative embodiment of the invention; and

FIGS. 8a and 8b illustrate an ultrasonic flow cell to enhance peel oil recovery in accordance with an alternative embodiment of the present invention. FIG. 8a is a perspective view; FIG. 8b is a cross-sectional view.

### DETAILED DESCRIPTION OF THE INVENTION

The methods and devices described herein are useful in enhancing the recovery of peel oil from mixtures containing citrus solids and water. The invention will be described primarily with reference to treating frit and water mixtures from citrus extractors. However, it should be understood the invention has applicability in treating a variety of types of citrus mixtures to which ultrasonic energy can be applied to enhance recovery of peel oil. The term “citrus solids,” as used herein, refers to frit (fine peel particles), whole peel (entire peel or large pieces thereof), peel particles, or other solid citrus material in which peel oil may be entrapped. Non-limiting examples of citrus fruit include orange, grapefruit, lemon, lime, and tangerine. In an alternative embodiment described below, sonic energy can be applied to citrus mixtures containing emulsified peel oil, wherein the sonic energy de-emulsifies the peel oil thus enabling its recovery from the mixture.

Ultrasonic Energy for Treating Citrus Solids

Systems for generating ultrasonic energy are available from commercial sources, e.g., Hielscher GmbH, Teltow, Del. The ultrasonic energy generated by such systems typically has a frequency of about 16-100 kHz and often from about 20-50 kHz. It is contemplated that systems may be developed which generate ultrasonic energy of frequencies greater than 100 kHz. The systems may include a transducer which provide discrete power units (e.g., 1 kW, 2 kW, 4 kW, 8 kW, 16 kW), or combinations and/or multiples thereof. Generally, these systems utilize one of two types of probes (sonotrodes) for administering ultrasonic energy. These include axial probes and radial probes, each of which is suitable for the methods described herein. Preferably, a low amplitude probe is used.

The ultrasonic energy usually has a frequency of about at least about 15 kHz, typically from about 16 to 100 kHz, and often from about 20-50 kHz. The ultrasonic energy usually has a power within from about 0.2 to 60 kW. By way of example, the ultrasonic energy may have a power within a range of about 0.2-30 kW or about 0.4-15 kW.

The flowrate of the citrus mixture can vary over a wide range depending on such factors as the type and number of extractors used. By way of example, the flowrate can range from about 5 to about 300 GPM and often ranges from about 50 to about 250 GPM or from about 100 to 200 GPM. In general, higher pressures in the ultrasound process (e.g., within the ultrasonic flow cell) yield improved peel oil recoveries. The flow of citrus mixture can be pressurized, for example, to from about 10 to about 50 psi.

Typically, the citrus mixture is subjected to ultrasonic energy at a specific energy of from about 1×10⁻⁴ to 1×10⁻¹ kW-hr per liter. Sometimes the citrus mixture is subjected to ultrasonic energy at a specific energy of from about 1×10⁻⁴ to 1×10⁻² kW-hr per liter, or from about 1×10⁻⁴ to 1×10⁻³ kW-hr per liter. For example, using a 6 kW ultrasonic generator and an orange frit and water mixture at flowrate of 50 GPM, ultrasonic energy can be applied at a specific energy of about 5.3×10⁻⁴ kW-hr per liter. In general for a continuous flow process, the required power (W) for a given volumetric flow (Q) can be calculated using the equation:

$${W}_{input} ( kWh \text{/} L ) = {W}_{spec} = \frac{Power \cdot of \cdot Sonotrode \cdot ( W )}{Q \cdot ( L \text{/} min ) \times 60 \cdot ( min \text{/} hr ) \times 1000 \cdot ( W \text{/} kW )}$$

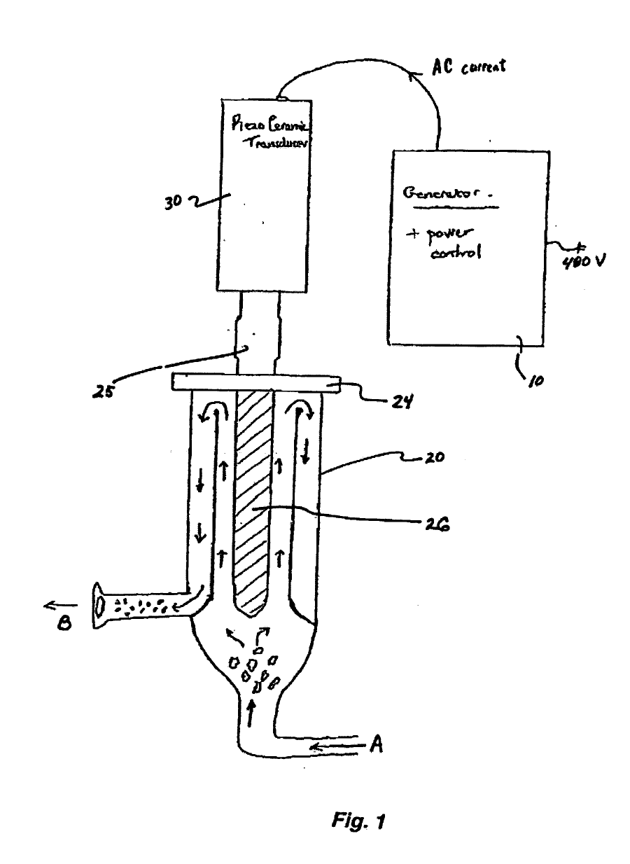

FIG. 1 schematically illustrates an apparatus for treating a frit and water mixture from FMC citrus extractors (not shown) with ultrasound to enhance peel oil recovery in accordance with a preferred embodiment of the invention. The apparatus has an 8 kW ultrasonic generator 10 and a piezo ceramic transducer 30 connected to a sonotrode 26 disposed in a flow cell 20. A booster 25 is provided to reduce or amplify ultrasonic energy as needed. An anti-vibrational flange 24 preferably is provided between the flow cell 20 and the booster 25 to reduce vibration.

The frit and water mixture is flowed through an inlet A into the bottom portion of the flow cell 20. As illustrated in FIG. 1, the mixture containing citrus solids flows upwardly through an interior channel of the flow cell 20 along the length of the sonotrode 26, and then downwardly through an outer channel of the flow cell 20 before exiting through an outlet B. The effluent contains peel oil which has been separated from the citrus solids. The peel oil can be separated from the mixture and recovered using conventional techniques.

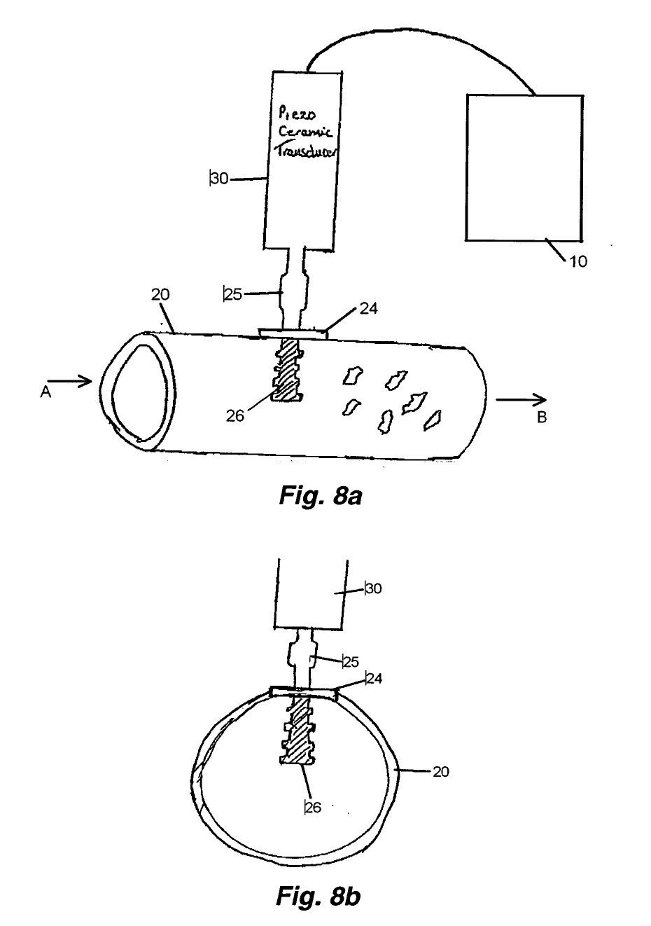

While an ultrasonic flow cell 20 of a particular configuration has been shown for separating peel oil from citrus solids, it should be understood that alternative configurations can be used. For example, a sonotrode can be positioned in a container for to facilitate a batch operation. Alternatively, a continuous process can be implemented using different sonotrode and flow pattern configurations. For example, as shown in FIGS. 8a and 8b, a sonotrode 26 can be positioned in an existing section of pipe 20 such that the mixture flows through an inlet A and around the sonotrode 26 which projects into the interior of the pipe 20. The mixture containing the separate peel oil exits the pipe 20 through outlet B. The apparatus can employ an ultrasonic generator 10 and a piezo ceramic transducer 30 as described above in the embodiment of FIG. 1. A booster 25 can be provided to reduce or amplify ultrasonic energy as needed, and an anti-vibrational flange 24 can be provided between the flow cell 20 and the booster 25 to reduce vibration.

Sonic Energy for De-Emulsifying Peel Oil

In an alternative embodiment of the invention, a citrus mixture containing emulsified peel oil is subjected to sonic energy to de-emulsify the peel oil, enabling its recovery from the citrus mixture. The citrus mixture may be an effluent stream from a citrus extractor, as described above, or may be another source of citrus material which contains emulsified peel oil. Suitable devices for producing sonic energy are commercially available. An example is the Sonic Splitter available from Etrema Company (Ames, Iowa). This device operates at a power of 500 Watts. Typical operating frequencies range from about 600 to 2,000 Hz, and preferably range from about 900 to 1,200 Hz.

FIG. 7 illustrates an example of a flow-through device that can be used for applying sonic energy to a citrus mixture. The mixture containing emulsified peel oil flows into an inlet A of a conduit and passes a vibrating plate 40. A sonic energy source 45 causes the plate 40 to vibrate at a frequency of about 600 to 2,000 Hz, which breaks the emulsion. The mixture containing de-emulsified peel oil exits the conduit at the location designated by arrow B. The flowrate of the citrus mixture typically ranges from about 5 to about 30 GPM. Other flow configurations alternatively can be used for continuous operation. The process alternatively can be carried out in batch mode. Conventional techniques, e.g., decantation, centrifugation, filtration, can be used for separating the de-emulsified peel oil from the mixture. The sonic treatment is effective for increasing the efficiency of such techniques in separating peel oil.

### EXAMPLES

The following examples are provided to illustrate the invention and should not be construed as limiting the scope of the invention.

### Example 1

This example illustrates applying ultrasonic energy to a frit and water mixture from FMC extractors to recover entrapped orange peel oil from the frit. Flow rates of 7, 14, 25, 50 and 62 GPM were used, while power was varied between 1 and 7 kW. Three different types of sonotrodes (low amplitude radial, low amplitude cascade and high amplitude cascade) were tested to evaluate different sonotrode/booster combinations. At these flow rates, no significant temperature change was observed, e.g., no more than a few degrees F.

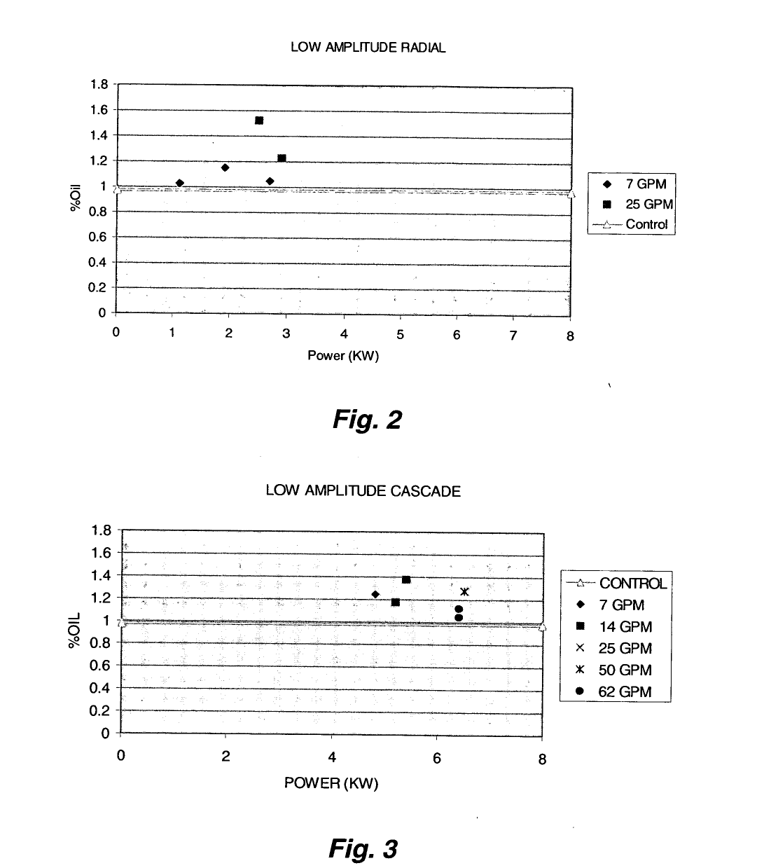

Samples were taken before and after the ultrasound test unit to limit variation in the control over time. Immediately after pulling a sample, the frit was separated from the emulsion using a metal screen. The emulsion was then subjected to oil analysis. As shown in FIGS. 2-5, control samples which were not subjected to ultrasound had an average orange peel oil recovery of about 1% (w/v).

FIG. 2 shows the orange peel oil recovery using the low amplitude radial probe, where the weighted average of the control samples is shown by a straight line, and the treated samples are plotted according to flowrate. Higher flowrate yielded higher recoveries, indicating that back pressure (at 50-62 GPM about 15-30 psi) aids the extraction process. FIG. 3 shows the same graph for the low amplitude cascade probe.

Similar to the results shown in FIG. 2, when using a low amplitude cascade probe it appears that increasing the flow rate increases oil recovery; however, between 50 and 62 GPM the oil recovery starts to drop off. This indicates the optimum flowrate-to-power ratio has been passed and thus residence time in the cell is too short.

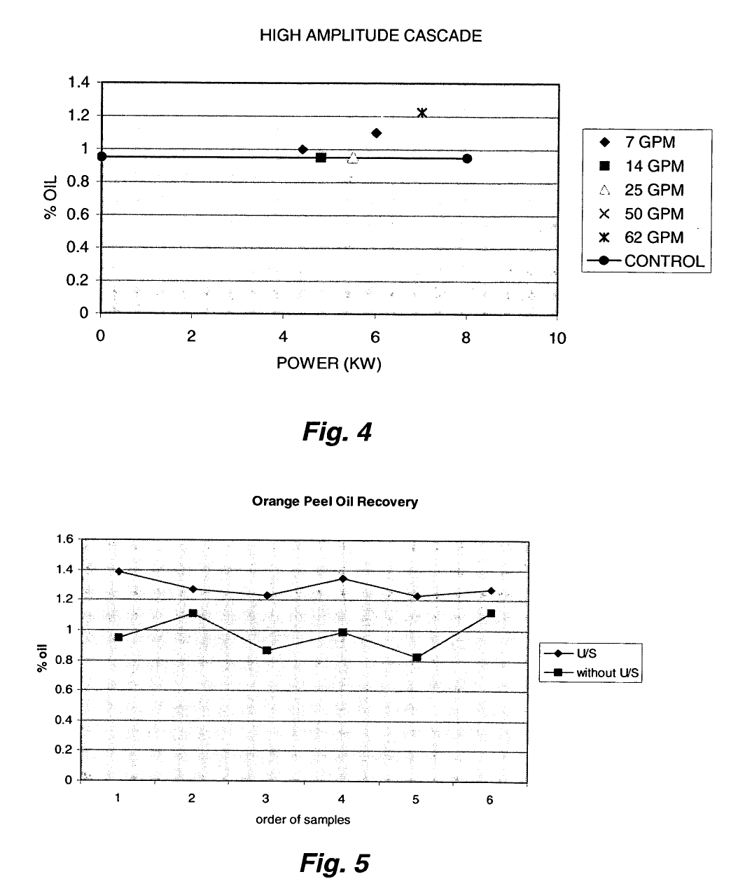

FIG. 4 presents the results for a high amplitude cascade probe. This probe is half the length of the low amplitude radial- and cascade probes and thus the energy density (kW/cm²) is much higher. The high amplitude probe was found to be less effective than the low amplitude probe in enhancing peel oil recovery.

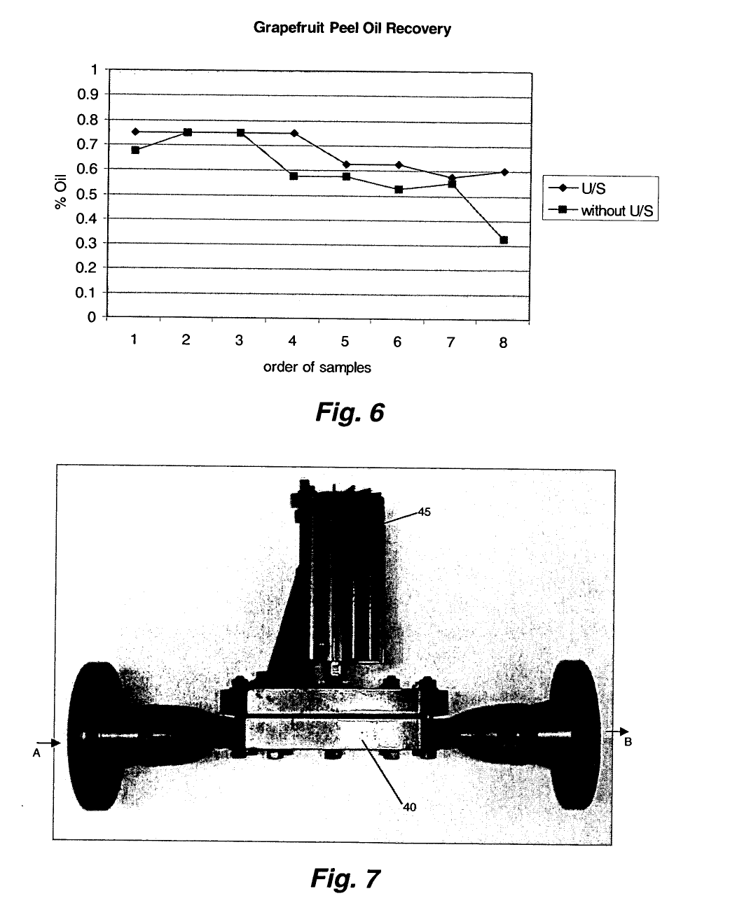

In order to measure the average improved recovery, a 3-4 hour test was performed using the low amplitude cascade probe, with a flowrate of 50 GPM and power of 6 kW. This corresponds to a specific energy of 5.3×10⁻⁴ kW-hr per liter. This test was done for both orange and grapefruit peel. Since this test was run in-line, the centrifuge efficiency was also measured and was found to be 10% higher for the orange frit test. Results are shown in FIGS. 5 and 6. The average increases in peel oil recovery over the control were 32% (orange, FIG. 5) and 15% (grapefruit, FIG. 6).

It will be understood that while the invention has been described in conjunction with specific embodiments thereof, the foregoing description and examples are intended to illustrate, but not limit the scope of the invention. Other aspects, advantages and modifications will be apparent to those skilled in the art to which the invention pertains, and these aspects and modifications are within the scope of the invention, which is limited only by the appended claims.

What is claimed is:

1. A process of enhancing peel oil extraction from citrus fruit, the process comprising:
providing a mixture containing citrus solids and water;
subjecting the citrus solids and water mixture to high power ultrasonic energy under conditions sufficient to separate peel oil from the citrus solids; and
recovering the peel oil.

2. The process of claim 1 wherein the citrus solids is obtained by extracting a citrus fruit selected from the group consisting of orange, grapefruit, lemon, lime, tangerine, and mixtures thereof.

3. The process of claim 1 wherein the citrus solids and water mixture is provided at a flowrate of from about 5 to about 300 GPM.

4. The process of claim 1 wherein ultrasonic energy is applied to the mixture at a specific energy of from about 1×10⁻⁴ to 1×10⁻¹ kW-hr ultrasonic energy per liter.

5. The process of claim 4 wherein ultrasonic energy is applied to the mixture at a specific energy of from about 1×10⁻⁴ to 1×10⁻² kW-hr ultrasonic energy per liter.

6. The process of claim 1, wherein the ultrasonic energy has a frequency of about 15-100 kHz.

7. The process of claim 1, wherein the citrus solids and water mixture is subjected to ultrasonic energy having a power of about 0.2-20 kW.

8. The process of claim 1 further comprising pressurizing the mixture to a pressure of from about 10 to about 50 psi.

9. The process of claim 1 wherein the citrus solids comprises frit.

10. The process of claim 1 wherein the citrus solids comprises whole peel.

11. The process of claim 1 wherein the citrus solids comprises peel particles.

12. A continuous process of extracting peel oil from citrus fruit selected from the group consisting of orange, grapefruit, lemon, lime, tangerine, and mixtures thereof, the process comprising:
flowing a citrus solids and water mixture from a citrus extractor at a flowrate of from about 5 to about 200 GPM, wherein the citrus solids comprises at least one of frit, whole peel, and peel particles, and wherein the citrus solids and water mixture is maintained at a pressure of from about 10 to about 50 psi;
subjecting the citrus solids and water mixture to high power ultrasonic energy under conditions sufficient to separate peel oil from the citrus solids, wherein the ultrasonic energy is applied to the citrus solids and water mixture at a specific energy of from about 1×10⁻⁴ to 1×10⁻² kW-hr ultrasonic energy per liter; and
recovering the peel oil.

13. A process of enhancing peel oil extraction from citrus fruit, the process comprising:
providing a citrus mixture comprising an extract of citrus fruit selected from the group consisting of orange, grapefruit, lemon, lime, tangerine, and mixtures thereof, the citrus mixture containing emulsified peel oil;
subjecting the citrus mixture to sonic energy under conditions sufficient to de-emulsify the peel oil; and
recovering the peel oil.

14. The process of claim 13 wherein the citrus mixture is provided at a flowrate of from about 5 to about 30 GPM.

15. The process of claim 13, wherein the sonic energy has a frequency of about 600 to 2,000 Hz.

16. The process of claim 15, wherein the sonic energy has a frequency of about 900 to 1,200 kW.

17. An apparatus for extracting peel oil from citrus fruit comprising:
an extractor for extracting water, oil, and citrus solids from citrus fruit;
a conduit for flowing from the extractor a citrus mixture containing citrus solids and water; and
an ultrasonic generator operatively connected to a probe for subjecting the citrus mixture to high power ultrasonic energy to separate peel oil from the citrus solids.

18. The apparatus of claim 17 further comprising means for pressurizing the citrus mixture to a pressure of from about 10 to about 50 psi.

19. The apparatus of claim 18 wherein the ultrasonic generator is configured to apply ultrasonic energy at a specific energy of from about 1×10⁻⁴ to 1×10⁻¹ kW-hr per liter.

20. The apparatus of claim 19 wherein the ultrasonic generator is configured to apply ultrasonic energy at a specific energy of from about 1×10⁻⁴ to 1×10⁻² kW-hr per liter.

21. The apparatus of claim 17, wherein the ultrasonic generator is configured to apply ultrasonic energy at a frequency of about 15-100 kHz.

22. The apparatus of claim 17, wherein the ultrasonic generator is configured to apply ultrasonic energy having a power of about 0.2-20 kW.

23. The apparatus of claim 17 wherein the probe comprises a low amplitude radial probe.

24. The apparatus of claim 17 wherein the probe comprises a low amplitude cascade probe.

25. An apparatus for extracting peel oil from citrus fruit comprising:
an extractor for extracting water, oil, and citrus solids from citrus fruit;
a conduit for flowing from the extractor a citrus mixture containing emulsified peel oil; and
a sonic generator operatively connected to a probe for subjecting the citrus mixture to sonic energy to de-emulsify the peel oil.

26. The apparatus of claim 25 wherein the sonic generator is configured to apply sonic energy at a frequency of from about 600 to 2,000 Hz.

27. The apparatus of claim 26 wherein the sonic generator is configured to apply sonic energy at a frequency of from about 900 to 1,200 Hz.
